(19) United States
(12) Patent Application Publication
(10) Pub. No.: US 2010/0248792 A1
(43) Pub. Date: Sep. 30, 2010

(54) Display Device and Mobile Terminal Device

(75) Inventor: Reiko Yamashita, Gifu (JP)

Correspondence Address: PROCOPIO, CORY, HARGREAVES & SAVITCH LLP, 525 B STREET, SUITE 2200, SAN DIEGO, CA, 92101, US

(73) Assignee: KYOCERA CORPORATION, Kyoto (JP)

(21) Appl. No.: 12/744,522

(22) PCT Filed: Nov. 26, 2008
(86) PCT No.: PCT/JP2008/071443

§ 371 Date: May 26, 2010

(30) Foreign Application Priority Data
Nov. 29, 2007 (JP) 2007-308194

(51) Int. Cl. H04M 1/00; H04N 9/31

(52) U.S. Cl. 455/566; 348/744

(57) ABSTRACT

[Object] To provide a display device and a mobile terminal device that can be reduced in size and weight by simplifying a configuration.

[Constitution] Laser lights from a projector module 31 enter a main reflective region 32M and a sub reflective region 32S for scanning by a movable mirror 330. The laser lights reflective on the main reflective region 32M of a first reflective mirror 32 are used to scan a back side of a main screen 34 through a second reflective mirror 33. This scanning allows a main image to be displayed on a front side of the main screen 34. Meanwhile, laser lights reflected on the sub reflective region 32S of the second reflective mirror 32 are used to scan a back side of a sub screen 35. This scanning allows a sub image to be displayed on a front side of the sub screen 35.

### TECHNICAL FIELD

The present invention relates to a display device, in particular, a display device that displays images on a plurality of display screens provided in different planes, and relates to a mobile terminal device, such as a mobile phone, including the display device.

### BACKGROUND ART

Conventionally, a clamshell mobile phone has a main screen and a sub screen. The sub screen is intended for providing a display on the mobile phone in a folded state, and is generally disposed on the back side of the main screen (Patent Document 1).

A display device for a screen display generally has a combination of a liquid crystal panel and a backlight. In a conventional mobile phone, screens have respective liquid crystal panels and backlights.

Meanwhile, in recent years, there has been known a mobile phone in which screens have respective liquid crystal panels and two liquid crystal panels have a backlight in common as a light source for achieving a simplified structure and the like (Patent Document 2).

Patent Document 1: JP 2005-333591 A

Patent Document 2: JP 2005-209618 A

### DISCLOSURE OF THE INVENTION

### Problem to be Solved by the Invention

However, the latter mobile phone has also screens with respective liquid crystal panels, and therefore requires respective circuits for driving and controlling the liquid crystal panels and respective control programs for the liquid crystal panels. Accordingly, there is a possibility that such a mobile phone cannot be significantly simplified in configuration.

The present invention solves such a problem, and an object of the present invention is to provide a display device and a mobile terminal device that can be reduced in size and weight by simplification of a configuration thereof.

### Means to Solve the Problem

A first aspect of the present invention relates to a display device. The display device of this aspect includes: a first image display part; a second image display part provided in a plane different from a plane in which the first image display part is provided; a projection part for emitting light constituting a projection image in accordance with an image signal; and a light-guiding part for, out of the light emitted from the projection part, guiding a light portion in a first projection region to the first image display part and guiding a light portion in a second projection region different from the first projection region to the second image display part.

According to the display device of the first aspect, one projection part can be used to display images as appropriate on the first image display part and the second image display part, two of which are provided in different planes. Therefore, it is not necessary to dispose two independently-driven display means on an individual basis, thereby realizing a simplified configuration and cost reduction. In addition, it is not needed to drive and control two individual display means, it is possible to simplify a control circuit and facilitate control processing.

In the display device of the first aspect, the light-guiding part may be configured to include: a first mirror part for reflecting the light portion in the first projection region; a second mirror part for reflecting the light portion in the second projection region toward the second image display part; and a third mirror part for reflecting the light reflected on the first mirror part toward the first image display part.

In this case, the first mirror part and the second mirror part may be formed by a common mirror to thereby reduce parts count.

In addition, both a mirror plane of the first mirror part and a mirror plane of the second mirror part or either of the two has a curved surface shape to widen a spread angle of the light portion entering therein. Accordingly, since the light for producing a projection image are widened in spread angle, it is possible to shorten a light path from the first mirror part or the second mirror part to the first image display part or the second image display part, thereby realizing size reduction of the device. Moreover, according to this configuration, the projection part can be smaller in size to make the device further compact.

Further, in the display device of the first aspect, the projection part may be configured to include a scan part for scanning with the light the first projection region and the second projection region.

A second aspect of the present invention relates to a mobile terminal device. The mobile terminal device of this aspect includes the display device of the first aspect. Consequently, the mobile terminal device of this aspect can bring about the same advantages as those of the display device of the first aspect.

In an embodiment described below, a main image display 21 corresponds to a “first image display part” in the present invention; a sub image display 22 to a “second image display part” in the present invention; a projector module 31 to a “projection part” in the present invention; and a first reflective mirror 32 to a “common mirror” in the present invention. Additionally, in the embodiment described below, a main reflective region 32M corresponds to a “first mirror part” in the present invention; a sub reflective region 32S to a “second mirror part” in the present invention; a second reflective mirror 33 to a “third mirror part” in the present invention; a main screen 34 to a “first image display part” in the present invention; and a sub screen 35 to a “second image display part” in the present invention.

### ADVANTAGE OF THE INVENTION

According to the present invention as stated above, it is possible to provide a display device and a mobile terminal device that can be reduced in size and weight and accomplishes cost reduction and simplified control processing by simplification of a configuration thereof.

Advantage or significance of the present invention will be further understood from the description of an embodiment below. However, the following embodiment is merely an example for carrying out the present invention, and the present invention is not limited by the following embodiment.

### BRIEF DESCRIPTION OF THE DRAWINGS

FIG. 1 is a diagram showing an external configuration of a mobile phone in an embodiment;

FIG. 2 is a diagram showing an internal structure of a display part in the embodiment;

FIG. 3 is a diagram showing a configuration of a projector module in the embodiment;

FIG. 4 is a functional block diagram showing an entire configuration of the mobile phone in the embodiment;

FIG. 5 is a functional block diagram showing a configuration related to driving of the projector module in the embodiment;

FIG. 6 is a diagram for describing a scanning state of laser lights and output states of the laser lights irradiated to a projection screen in the embodiment;

FIG. 7 is a diagram showing schematically a timing for driving an actuator and a timing for driving a laser in the embodiment; and

FIG. 8 is a diagram showing a display example of a projection image produced by the projector module in the embodiment, and display examples of screen displays on a main image display part and a sub image display part.

However, the attached drawings are intended only for illustration and do not limit the scope of the present invention.

### BEST MODE FOR CARRYING OUT THE INVENTION

An embodiment of the present invention will be described below with reference to the attached drawings. In this embodiment, a display device of the present invention is applied to a mobile phone.

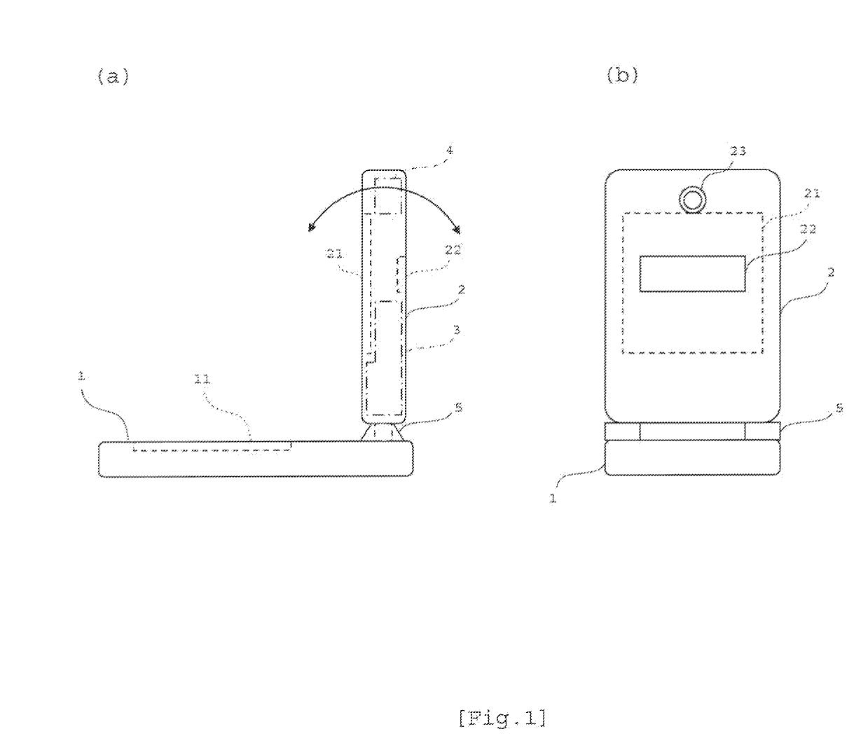

FIG. 1 is a diagram showing an external configuration of the mobile phone: FIG. 1 (a) is a side view of the mobile phone with a turning part 2 made upright in an almost vertical position with respect to a base part 1; and FIG. 1 (b) is a rear view of the mobile phone in the same state.

The mobile phone includes the base part 1 and the turning part 2. The base part 1 has a keypad 11 on a front side thereof. The keypad 11 includes a key for switching various modes (camera shooting mode, e-mail transmission/reception mode, Internet mode, and projector mode), a call start key, a call end key, number/character input keys, and others.

The turning part 2 has a main image display 21 on a front side thereof, and has a sub image display 22 on a rear side thereof. As shown in FIG. 1 (b), the main image display 21 has a shape of a slightly vertically long rectangle. Meanwhile, the sub image display 22 is smaller than the main image display 21 and has a shape of a horizontally long rectangle. The turning part 2 has inside a display device 3 for displaying various images in various modes on the main image display 21 and the sub image display 22. In addition, the turning part 2 has inside a camera module 4. The turning part 2 has on a rear side thereof a lens window 23 for capturing an image of an object into the camera module 4.

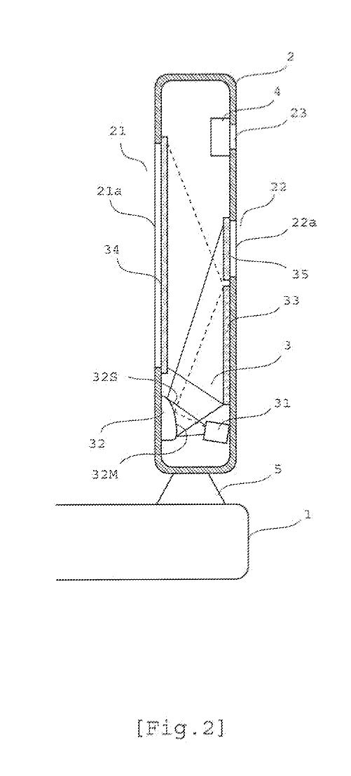

FIG. 2 is a diagram showing an internal structure of the turning part 2. As stated above, the turning part 2 has inside the display device 3 and the camera module 4.

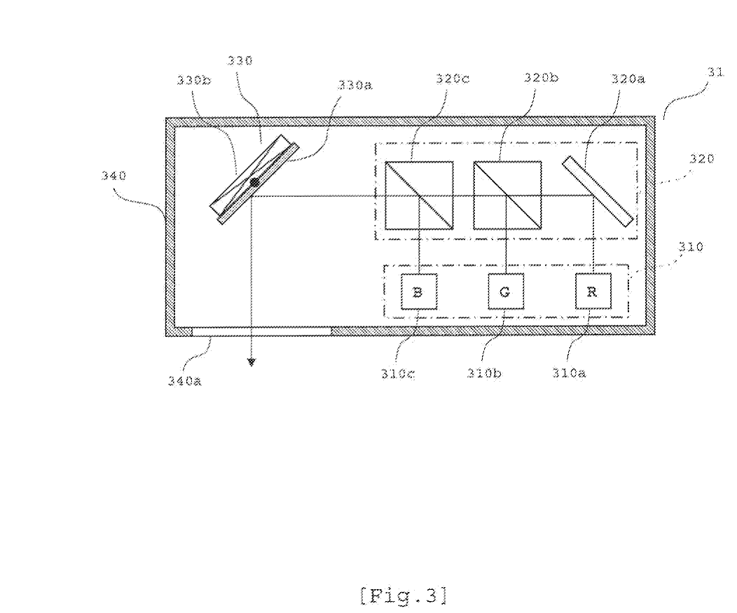

As shown in FIG. 3, the display device 3 includes a projector module 31, a first reflective mirror 32, a second reflective mirror 33, a main screen 34, and a sub screen 35.

The projector module 31 includes a light source part 310, a light guide optical system 320, and the movable mirror 330. The light source part 310, the light guide optical system 320, and the movable mirror 330 are housed in a case 340.

The light source part 310 emits three laser lights of red, green, and blue. Accordingly, the light source part 310 includes a red laser portion 310a, a green laser portion 310b, and a blue laser portion 310c. The red laser portion 310a emits a red laser light (hereinafter referred to as “R light”); the green laser portion 310b emits a green laser light (hereinafter referred to as “G light”); and the blue laser portion 310c emits a blue laser light (hereinafter referred to as “B light”).

The light guide optical system 320 is composed of a reflective mirror 320a and two dichroic mirrors 320b and 320c. The dichroic mirror 320b reflects G light and lets R light through. The dichroic mirror 320c reflects B light and lets R and G lights through.

The R light emitted from the red laser portion 310a is reflected on the reflective mirror 320a and is bent about 90 degrees. Then, the R light passes through the two dichroic mirrors 320b and 320c and enters the movable mirror 330. In addition, the G light emitted from the green laser portion 310b is reflected on the dichroic mirror 320b and is bent about 90 degrees. Then, the G light passes through the dichroic mirror 320c and enters the movable mirror 330. In addition, the B light emitted from the blue laser portion 310c is reflected on the dichroic mirror 320c and is bent about 90 degrees, and then enters the movable mirror 330.

The movable mirror 330 is composed of micro electro mechanical systems (MEMS), and includes a mirror 330a and an actuator 330b. The actuator 330b is a biaxial type and rotates the mirror 330a in a two-dimensional direction with the use of driving force such as an electromagnetic force, a piezoelectric element, an electrostatic force, or the like.

The R, G, and B lights having entered the mirror 330a of the movable mirror 330 are reflected in a direction in accordance with an angle of turning of the mirror 330a. When the mirror 330a is turned by the actuator 330b in a two-dimensional direction, a projection plane is scanned two-dimensionally with the R, G and B lights. Accordingly, an image is projected with a combination of the R, G, and B lights onto the projection plane.

The case 340 is made from a metal material for imparting a heat radiating property. The case 340 has a projection opening 340a for emitting laser lights reflected on the movable mirror 330.

Returning to FIG. 2, the projector module 31 is placed in an interior of the turning part 2 on a lower part of a rear side thereof. Laser lights (R, G, and B lights) emitted from the projection opening 340a of the projector module 31 travel toward the front side of the turning part 2.

The first reflective mirror 32 is placed in the interior of the turning part 2 on a lower part of a front side thereof so as to be opposed to the projector module 31. A reflective plane of the first reflective mirror 32 is convexed and aspheric-shaped, and includes a lower-side main reflective region 32M and an upper-side sub reflective region 32S.

The laser lights from the projector module 31 enter the main reflective region 32M and the sub reflective region 32S at the time of scanning by the movable mirror 330. Then, the laser lights reflected on the main reflective region 32M travel toward the second reflective mirror 33, and the laser lights reflected on the sub reflective region 32S travel toward the sub screen 35. The laser lights are widened in angle (increased in swing angle) simultaneously with reflection by the first reflective mirror 32.

The second reflective mirror 33 is disposed on the rear side of interior of the turning part 2, above the projector module 31. A reflective plane of the second reflective mirror 33 has a flat shape. It is only the laser lights reflected on the main reflective region 32M of the first reflective mirror 32 that enter the second reflective mirror 33. The laser lights reflected on the second reflective mirror 33 travel toward the main screen 34.

The main screen 34 is a rear-projection screen (transmissive screen), and is disposed on an inner side of the main display window 21a on the front side of the turning part 2. The main screen 34 constitutes the main image display 21 together with the main display window 21a. The laser lights reflected on the second reflective mirror 33 are irradiated to a back side of the main screen 34.

Accordingly, the laser lights reflected on the main reflective region 32M of the first reflective mirror 32 are used to scan the back side of the main screen 34 through the second reflective mirror 33. An image projected by the scanning onto the back side of the main screen 34 passes through the interior of the main screen 34 and is displayed on the front side of the main screen 34.

The sub screen 35 is a rear-projection screen (transmissive screen), and is disposed on an inner side of the sub display window 22a on the rear side of the turning part 2, immediately above the second reflective mirror 33. The sub screen 35 constitutes the sub image display 22 together with the sub display window 22a. The laser lights reflected on the sub reflective region 32S of the first reflective mirror 32 are irradiated to the back side of the sub screen 35 without entering the second reflective mirror 33.

Accordingly, the laser lights reflected on the sub reflective region 32S of the first reflective mirror 32 are used to scan the back side of the sub screen 35. An image projected by the scanning onto the back side of the sub screen 35 passes through the interior of the sub screen 35 and is displayed on the front side of the sub screen 35.

In the first reflective mirror 32, the main reflective region 32M has a plane in which an image projected from the projector module 31 onto the main reflective region 32M is enlarged and projected in an appropriate size on the main screen 34. In addition, the sub reflective region 32S has a plane in which an image projected from the projector module 31 onto the sub reflective region 32S is enlarged and projected in an appropriate size on the sub screen 35.

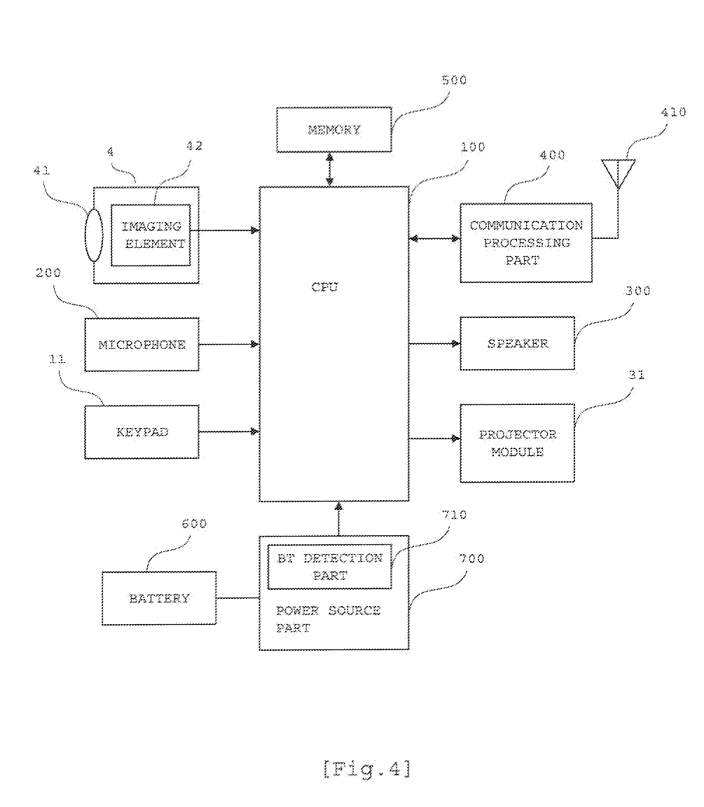

FIG. 4 is a functional block diagram showing an entire configuration of the mobile phone. The mobile phone includes the keypad 11, projector module 31, the camera module 4, and also includes a CPU 100, a microphone 200, a speaker 300, a communication processing part 400, a memory 500, a battery 600, and a power source part 700.

The camera module 4 is composed of an imaging lens 41, an imaging element 42, and the like.

The imaging lens 41 forms an image of an object on the imaging element 42. The imaging element 42 is formed by a CCD, for example, and generates an imaging signal in accordance with a captured image and sends the same to the CPU 100.

The microphone 200 converts an audio signal into an electric signal and sends the same to the CPU 100. The speaker 300 reproduces the audio signal from the CPU 100 in audio representation.

The communication controlling part 400 converts audio signals, image signals, text signals and the like, from the CPU 100 into radio signals, and transmits the same to a base station via an antenna 410. The communication processing part 400 also converts radio signals received via the antenna 410 into audio signals, image signals, text signals and the like, and sends the same to the CPU 100.

The memory 500 stores image data shot by the camera module 4, image data captured from the outside via the communication processing part 400, text data (e-mail data) and the like, in predetermined file formats.

The battery 600 is intended to supply power to the CPU 100 and other components of the mobile phone, and is formed by a secondary battery. The battery 600 is connected to the power source part 700.

The power source part 700 converts a voltage of the battery 600 into voltages of magnitudes required for the components of the mobile phone, and supplies the same to the components. In addition, the power source part 700 charges the battery 600 by supplying the battery 600 with power supplied from an input of an external power source (not shown).

The power source part 700 has a battery voltage detection part 710 (hereinafter referred to as “BT detection part”). The BT detection part 710 detects a voltage of the battery 600 and sends the same to the CPU 100.

The CPU 100 outputs control signals to the components such as the speaker 300 and projector module 31, in accordance with input signals from the components such as the keypad 11, the microphone 200, and the imaging element 42, to thereby carry out communication processing and various mode operations.

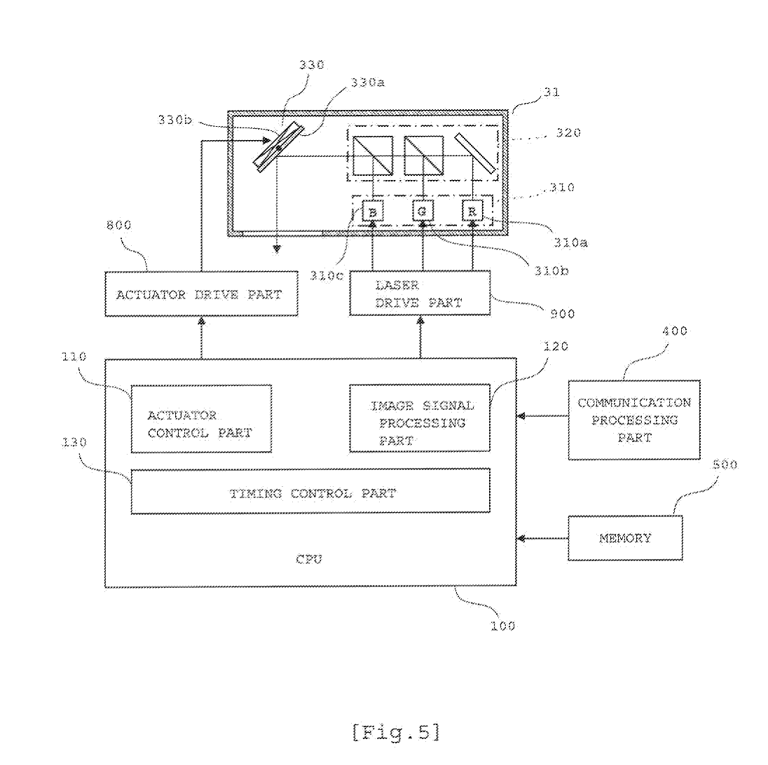

FIG. 5 is a functional block diagram showing a configuration relating to driving of the projector module 31 in the mobile phone. In FIG. 4, the components not relating to driving control of the projector module 31 in the configuration of FIG. 4 described above, are omitted.

The mobile phone further includes an actuator drive part 800 and a laser drive part 900. In addition, the CPU 100 includes an actuator control part 110, an image signal processing part 120, and a timing control part 130.

The actuator control part 110 controls driving of the actuator 330b in the movable mirror 330, and outputs a control signal to the actuator drive part 800 with a predetermined drive timing. In accordance with the control signal, the actuator drive part 800 outputs a drive signal to the actuator 330b.

The image signal processing part 120 controls driving of the light source part 310. The image signal processing part 120 produces an image to be displayed on the main image display 21 and the sub image display 22, in a memory (not shown) as a working area prepared in the CPU 100, and outputs RGB signals for display of the produced image to the laser drive part 900 with a predetermined drive timing. In addition, the image signal processing part 120 captures image data transmitted from the imaging element 42, image data stored in the memory 500, image data received via the communication processing part 400, and the like. Then, the image signal processing part 120 generates an RGB signal from the captured image data, and outputs the generated RGB signal to the laser drive part 900 with a predetermined drive timing. In accordance with the RGB signal, the laser drive part 900 outputs a drive signal to the red laser portion 310a, the green laser portion 310b, and the blue laser portion 310c in the light source part 310.

The timing control part 130 adjusts a timing for driving the actuator 330b by the actuator control part 110 and a timing for driving the light source part 310 by the image signal processing part 120.

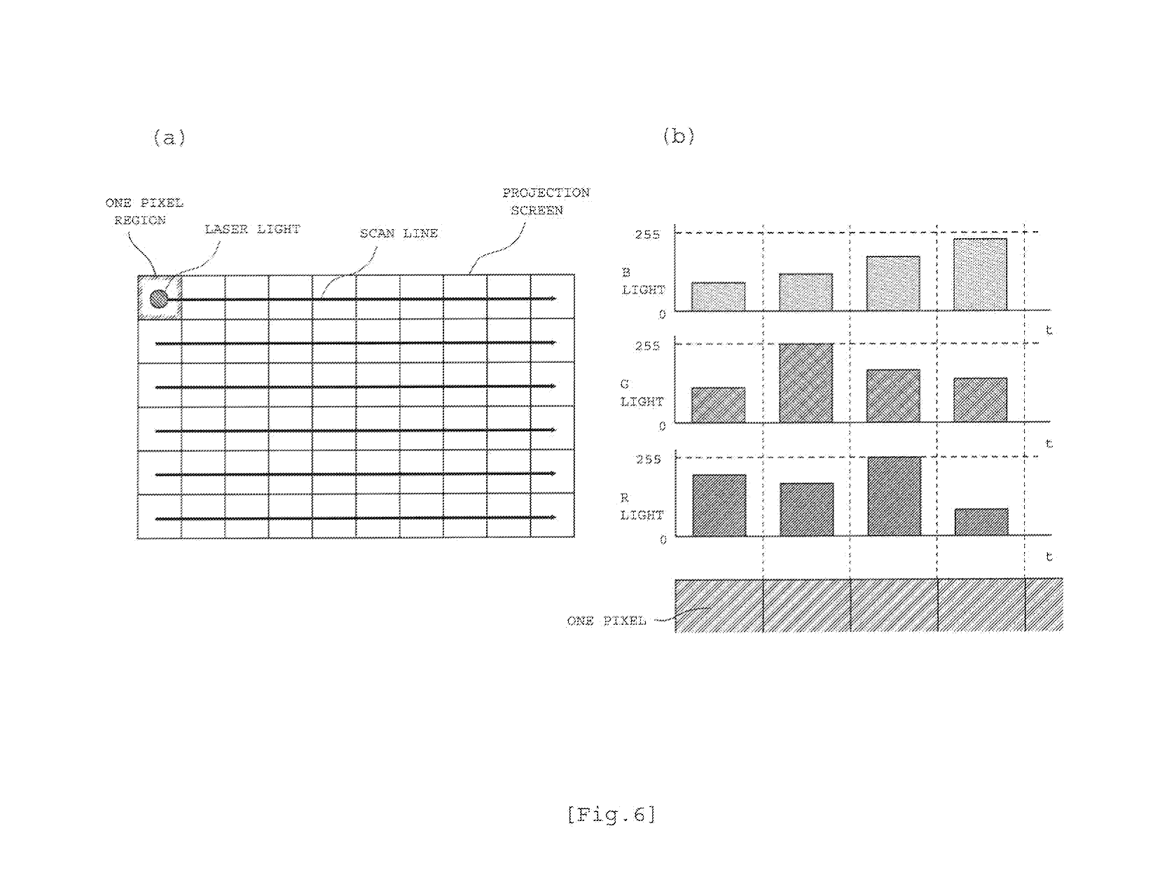

FIG. 6 is a diagram for describing a projection screen produced by the projector module 31 and an output state of laser lights irradiated onto the projection screen: FIG. 6 (a) is a diagram showing a scan state of the laser lights for producing the projection screen; and FIG. 6 (b) is a diagram showing an output state of the laser lights in pixel regions. In FIG. 6 (b), vertical axes indicate gradations of the laser lights (magnitudes of laser power), and horizontal axes indicate irradiation times of the laser lights.

As shown in FIG. 6 (a), when the mirror 330a is turned by the actuator 330b, horizontal scanning is performed using the laser lights (R, G, and B lights). The laser light scanning is carried out only according to the number of horizontal pixels as shown by solid line arrows (scan lines) in FIG. 6 (a). The mirror 330a is turned in such a manner that, upon completion of a one-line scan, the laser lights come to a start point of a next scan line. In the same manner, laser light scanning is subsequently carried out in the horizontal direction and then the mirror 330a is turned so as to set a radiation position of the laser lights at a start point of a next scan line. The scan lines exist in correspondence with the number of vertical pixels. The mirror 330a is turned in such a manner that, upon completion of scanning in a lowermost scan line, the laser lights come to a start point of an uppermost scan line. Accordingly, one cycle of scanning is now completed for one screen, and then such a scanning operation is repeated during projection.

As shown in FIG. 6 (b), while laser power is adjusted as corresponding to proper gradation for each of the pixel regions, the laser lights are irradiated for a predetermined period of time for each of the pixel regions. At that time, the color of one pixel region is determined in accordance with the laser light gradations. The gradations of the laser lights are each adjusted by a magnitude of laser power. In this embodiment, the gradations are provided in 256 levels. In addition, the brightness (light intensity) of one pixel region is adjusted by a total amount of laser lights applied to the pixel region, that is, an irradiation time of the laser lights. Even if the irradiated lights are unchanged in intensity, the projected image feels brighter to a viewer with an increased irradiation time (an increased total amount of lights).

In such a manner as stated above, the projection plane is scanned with three laser lights with gradations changed for each pixel region, to thereby project an intended picture (still image or moving image) on the projection screen. The projection plane is not scanned with the laser lights simultaneously, but is scanned with R light, G light, and B light in orderly sequence for each screen, for example. Even if scanning is performed with the laser lights in a sequential manner, one scanning operation is completed in an extremely short time, and therefore the projected image appears as one color picture with a combination of three colors, in the eyes of a viewer by persistence of vision. As a matter of the course, alternatively, R light, G light and B light may be emitted simultaneously and combined at the light guide optical system 320, and then enter the movable mirror 330.

In the display device 3, the main screen 34 and the sub screen 35 constitute a projection screen described above with reference to FIG. 6 (a).

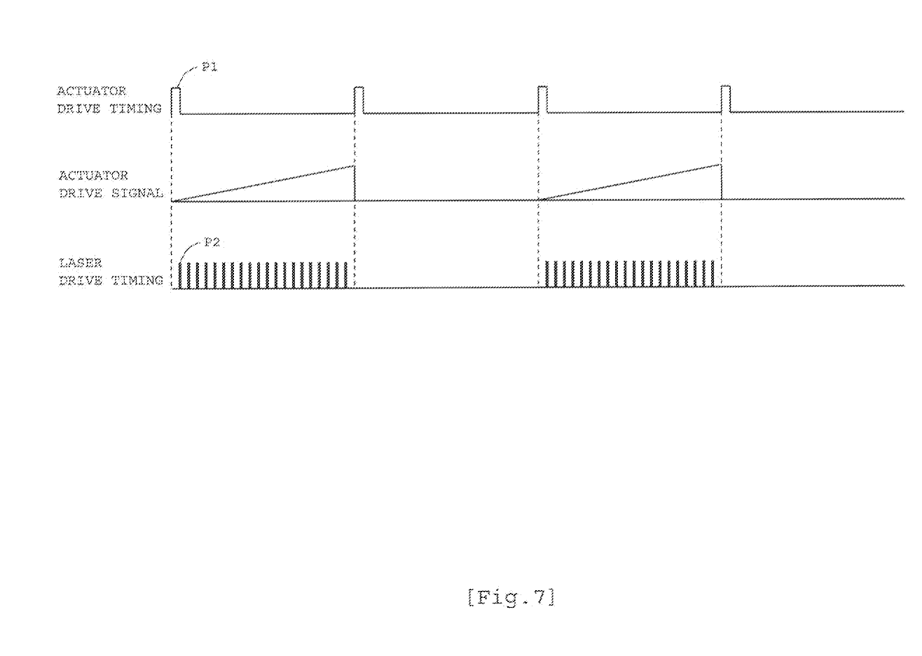

FIG. 7 is a diagram showing schematically a timing for driving the actuator and a timing for driving the laser. As shown in FIG. 7, a timing pulse P1 for driving the actuator 43b is output at a constant frequency. In synchronization with the timing pulse P1, a drive signal is output to the actuator 330b. In addition, in synchronization with the timing pulse P1, a timing pulse P2 for driving the laser portions 310a, 310b, and 310c is output by the number of horizontal pixels at a frequency corresponding to one pixel region. In synchronization with the timing pulse P2, a drive signal is output to the laser portions 310a, 310b, and 310c. This brings about operational synchronization between the actuator 330b and the laser portions 310a, 310b, and 310c, which allows the laser lights to be properly irradiated to each of the pixel regions.

Although, in FIG. 7, a drive signal of the actuator 330b is schematically represented as a simple rump signal, the drive signal actually constitutes a signal configured as to drive the mirror 330a two-dimensionally for horizontal laser light scanning.

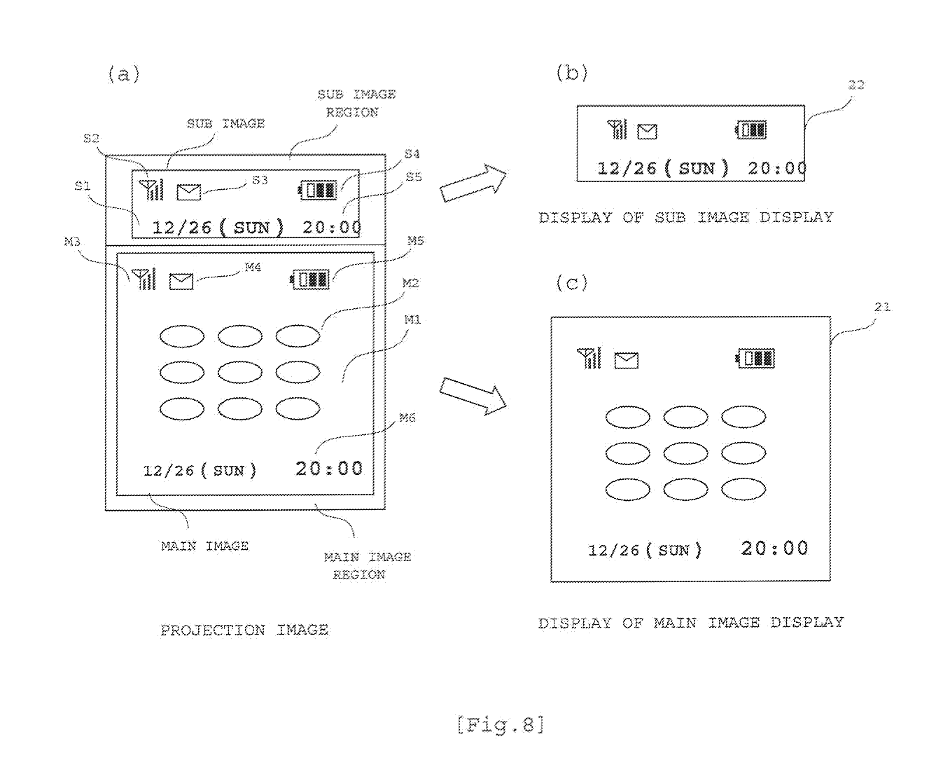

FIG. 8 is a diagram showing a display example of a projection image produced by the projector module 31 and a display example of screen displays on the main image display 21 and the sub image display 22: FIG. 8 (a) shows the projection image produced by the projector module 31; FIG. 8 (b) shows the screen display on the sub image display 22; and FIG. 8 (c) shows the screen display on the main image display 21.

As shown in FIG. 8 (a), a region of projection image produced by the projector module 31 is partitioned into an upper main image region and a lower sub image region. The main image region renders a main image for display on the main image display 21. Meanwhile, the sub image region renders a sub image for display on the sub image display 22. The image signal processing part 120 generates an image signal to project a projection image into which the main image and the sub image are integrated.

The main image includes a background image M1; an image M2 for selection of various modes disposed at a center of the background image M1; an image M3 indicative of reception status of an antenna; an image M4 indicative of incoming e-mail message(s); an image M5 indicative of a remaining battery level, the images M3, M4 and M5 are disposed on an upper part of the background image M1; and an image M6 indicative of the date disposed on a lower part of the background image M1, for example.

The sub image includes a background image S1; an image S2 indicative of reception status of an antenna; an image S3 indicative of incoming e-mail message(s); an image S4 indicative of a remaining battery level, the images S2, S3 and S4 are disposed on an upper part of the background image S1; and an image S5 indicative of the date disposed on a lower part of the background image S1, for example.

In projection of the main image and the sub image, the movable mirror 330 and the light source part 310 are driven. Accordingly, the sub image region is first scanned with laser lights to project the sub image, and then the main image region is scanned with laser lights to project the main image.

At that time, the laser lights for scanning the sub image region are configured to enter the sub reflective region 32S of the first reflective mirror 32. Therefore, the laser lights for scanning the sub image region are reflected on the sub reflective region 32S of the first reflective mirror 32, and then are irradiated to the sub screen 35. Accordingly, as shown in FIG. 8 (b), the sub image is displayed on the sub image display 22. This image is a standard image displayed on the sub image display 22 to provide basic information.

Meanwhile, the laser lights for scanning the main image region are configured to enter the main reflective region 32M of the first reflective mirror 32. Therefore, the laser lights for scanning the main image region are reflected on the main reflective region 32M of the first reflective mirror 32, and then are irradiated to the main screen 34 through the second reflective mirror 33. Accordingly, as shown in FIG. 8 (c), the main image is displayed on the main image display 21. This image is a mode selection image displayed for selection of various modes.

As stated above, when one projection image containing the sub image and the main image is projected from the projector module 31, the images are displayed simultaneously on the main image display 21 and the sub image display 22.

The mode selection image and the standard image are not necessarily displayed at the same time. Therefore, the mobile phone may be configured in such a manner that: when the mobile phone is folded, the mode selection image is not displayed in the main image display 21 but the standard image is displayed in the sub image display 22; and when the mobile phone is unfolded, the standard image is not displayed in the sub image display 22 but the mode selection image is displayed in the main image display 21, for example. In this case, the image signal processing part 120 generates an image signal for the main image and an image signal for the sub image separately. In addition, when only the sub image display 22 is to be displayed, only the sub image region is scanned with laser lights, and when only the main image display 21 is to be displayed, only the main image region is scanned with laser lights.

At that time, this embodiment may be configured in such a manner that the movable mirror 330 is driven to scan all the image regions and the light source part 310 is driven only for an image region onto which an image is to be projected. This eliminates the need for modifying drive control of the movable mirror 330, thereby realizing a simplified control operation.

Meanwhile, this embodiment may be configured in such a manner that the movable mirror 330 is driven to scan only an image region onto which an image is to be projected. This shortens a time required for scanning one image area, whereby laser lights can return in a shorter time to the same pixel region for next-time irradiation. Accordingly, it is possible to obtain the image area with the same level of brightness by irradiating a decreased amount of light to one pixel region each time. Therefore, power consumption can be reduced by driving the light source part 310 so as to irradiate a decreased amount of light to one pixel region, for example, so as to shorten the irradiation time t1 shown in FIG. 6.

Alternatively, this embodiment may be configured to allow a user to switch by a selecting operation between the former mode in which images are displayed on both of the main image display 21 and the sub image display 22 simultaneously and the latter mode in which image is displayed on either one of the main image display 21 and the sub image display 22 in a switched manner.

In the display example described above, it is not necessarily required to display images on the main image display 21 and the sub image display 22 simultaneously. Alternatively, a possible display configuration will be described below, for example, in which images need to be displayed on both of the main image display 21 and the sub image display 22 simultaneously.

Specifically, when photo shooting is performed in the camera shooting mode, the main image display 21 may display an image of an object captured by the imaging element 42, and at the same time, the sub image display 22 may display information for notifying that camera shooting is being performed, with the message “shooting” or the like. In such a configuration, a display on the sub image display 22 notifies the user that camera shooting is being performed, thereby to prevent secret photographing.

Alternatively, the main image display 21 may display an image of an object captured by the imaging element 42, and at the same time, the main image display 21 and the sub image display 22 may each provide an indication of a countdown message such as “3, 2, 1.” In such a configuration, it is easy to press a shutter button with a proper timing, thereby facilitating a camera shooting operation.

According to this embodiment as stated above, the one projector module 31 can be used to display images on the main image display 21 and the sub image display 22, two of which are provided in different planes, thereby realizing a simplified configuration. Therefore, the turning part 2 can be reduced in size and weight to thereby make the mobile phone compact and lightweight.

Moreover, only the one projector module 31 can be used to display the main image display 21 and the sub image display 22 simultaneously, which allows prevention of secret camera shooting and an indication of a countdown message as stated above. This increases the usage patterns of the mobile phone.

Further, in this embodiment, the first reflective mirror 32 can widen the swing angles of laser lights from the projector module 31, thereby shortening light paths to the main screen 34 and the sub screen 35 from the first reflective mirror 32. This allows the turning part 2 to be reduced in size and weight.

In the foregoing embodiment, both the laser lights guided to the main screen 34 and the laser lights guided to the sub screen 35 are widened in angle (increasing swing angles) at the first reflective mirror 32. Alternatively, the first reflective mirror 32 may have a surface shape so as to widen only the angle of the laser light guided to the main screen 34 of a larger screen size, or the first reflective mirror 32 may have a surface shape so as to widen only the angle of the laser light guided to the sub screen 35.

Further, in the foregoing embodiment, the main reflective region 32M guiding laser lights to the main screen 34 and the sub reflective region 32S guiding laser lights to the sub screen are disposed on the first reflective mirror 32. Alternatively, two mirrors may be disposed so as to guide laser lights to the main screen 34 and the sub screen 35, respectively.

Moreover, in this embodiment, the image signal processing part 120 generates an image signal for the main image rendered on the main image region and an image signal for the sub image rendered on the sub image region. Then, the laser lights for forming the main image are reflected on the second reflective mirror 33 and are irradiated to the main screen 34 to thereby display the main image on the main screen 34. In addition, laser lights for forming the sub image are irradiated to the sub screen 35 without entering the second reflective mirror 33 to thereby display the sub image on the sub screen 35. In such a configuration, it is possible to display corresponding images on the main image display 21 and the sub image display 22.

Although the embodiment of the present invention is as described above, the present invention is not limited to this embodiment. In addition, the embodiment of the present invention may be modified in various manners other than those described above.

For example, the different planes may not be opposite to each other, unlike a front side and a rear side. In addition, the image displays provided in different planes may not be differentiated between a main image display and a sub image display (with a difference in size). Further, the image displays are not limited to two locations and may be disposed at three or more locations.

Moreover, the projector module 31 is not limited to the scan type and may be a projection device of any other type.

Besides, the embodiment of the present invention may be modified as appropriate in various manners within the scope of a technical idea shown in the claims.

1. A display device, comprising:
a first image display part;
a second image display part provided in a plane different from a plane in which the first image display part is provided;
a projection part for emitting light constituting a projection image in accordance with an image signal; and
a light-guiding part for, out of the light emitted from the projection part, guiding a light portion in a first projection region to the first image display part and guiding a light portion in a second projection region different from the first projection region to the second image display part.

2. The display device according to claim 1, wherein
the light-guiding part include:
a first mirror part for reflecting the light portion in the first projection region;
a second mirror part for reflecting the light portion in the second projection region toward the second image display part; and
a third mirror part for reflecting the light reflected on the first mirror part toward the first image display part.

3. The display device according to claim 2, wherein
both a mirror plane of the first mirror part and a mirror plane of the second mirror part or either of the two has a curved surface shape to widen a spread angle of the light entering therein.

4. The display device according to claim 2, wherein
the first mirror part and the second mirror part are formed by a common mirror.

5. The display device according to claim 4, wherein
both a mirror plane of the first mirror part and a mirror plane of the second mirror part or either of the two has a curved surface shape to widen a spread angle of the light entering therein.

6. The display device according to claim 1, wherein
the projection part includes a scan part for scanning with the light the first projection region and the second projection region.

7. A mobile terminal device, comprising a display device, wherein
the display device including:
a first image display part;
a second image display part provided in a plane different from a plane in which the first image display part is provided;
a projection part for emitting light constituting a projection image in accordance with an image signal; and
a light-guiding part for, out of the light emitted from the projection part, guiding a light portion in a first projection region to the first image display part and guiding a light portion in a second projection region different from the first projection region to the second image display part.

8. The mobile terminal device according to claim 7, wherein
the light-guiding part include:
a first mirror part for reflecting the light portion in the first projection region;
a second mirror part for reflecting the light portion in the second projection region toward the second image display part; and
a third mirror part for reflecting the light reflected on the first mirror part toward the first image display part.

9. The mobile terminal device according to claim 8, wherein
both a mirror plane of the first mirror part and a mirror plane of the second mirror part or either of the two has a curved surface shape to widen a spread angle of the light entering therein.

10. The mobile terminal device according to claim 8, wherein
the first mirror part and the second mirror part are formed by a common mirror.

11. The mobile terminal device according to claim 10, wherein
both a mirror plane of the first mirror part and a mirror plane of the second mirror part or either of the two has a curved surface shape to widen a spread angle of the light entering therein.

12. The mobile terminal device according to claim 7, wherein
the projection part includes a scan part for scanning with the light the first projection region and the second projection region.
